(19) United States
(12) Patent Application Publication
(10) Pub. No.: US 2023/0366520 A1
(43) Pub. Date: Nov. 16, 2023

(54) Rechargeable Lamp

(71) Applicant: Stella Lighting Inc., Springfield, OR (US)

(72) Inventor: Nathan W. Wiedenmann, Springfield, OR (US)

(73) Assignee: Stella Lighting Inc., Springfield, OR (US)

(21) Appl. No.: 18/199,046

(22) Filed: May 18, 2023

Related U.S. Application Data
(63) Continuation of application No. PCT/US2021/059790, filed on Nov. 17, 2021.
(60) Provisional application No. 63/115,576, filed on Nov. 18, 2020.

(51) Int. Cl. F21S 9/02; F21S 6/00

(52) U.S. Cl. CPC F21S 9/02; F21S 6/003

(57) ABSTRACT

A rechargeable lamp includes a charging base and a lamp. In a charging arrangement the charging base and a base of the lamp are engaged so that the charging base supports the lamp in an upright position and a charger therein charges a rechargeable electrical power source of the lamp. In a separated arrangement, the lamp is portable and self-supporting in an upright position with the lamp base positioned on a substantially horizontal support surface. In some instances the recharging is wireless; in those instances other wirelessly rechargeable devices can be recharged on the charging base when it is separated from the lamp.

This application is a continuation of App. No. PCT/US2021/059790 entitled “Rechargeable lamp” filed 17 NOV 2021, which claims priority of U.S. Provisional App. No. 63/115,576 entitled “Rechargeable lamp” filed 18 NOV 2020, both of said applications being incorporated herein by reference in their entireties.

### FIELD OF THE INVENTION

The field of the present invention relates to lamps. In particular, rechargeable lamps and methods of their use are disclosed herein.

### SUMMARY

An inventive rechargeable lamp includes a charging base and a lamp. The charging base includes an electrical charger and a connection for an external electrical power source. The lamp comprises a lamp base, a lamp neck, a lamp head including a light source, and a rechargeable electric power source structured and connected for powering the light source. The charging base and the lamp base are moveable between a charging arrangement and a separated arrangement. In the charging arrangement, the charging base and the lamp base are engaged so that the charging base supports the lamp in an upright position and the charger charges the rechargeable electrical power source. In the separated arrangement, the lamp is portable and self-supporting in an upright position with the lamp base positioned on a substantially horizontal support surface.

A method for using the inventive rechargeable lamp comprises: (A) connecting the charging base to an external electrical power source; (B) positioning the lamp on the charging base so that the charging base and lamp are in the charging arrangement; (C) at least partially charging the rechargeable electric power source of the lamp; and (D) removing the lamp from the charging base and, with the charging base and the lamp in the separated arrangement, positioning the lamp in a desired location for providing illumination.

In some instances the charging base can include a first set of one or more inductive coils and the lamp base can include a second set of one or more inductive coils. With the charging base and the lamp base in the charging arrangement, the first and second sets of conductive coils are inductively coupled with one another so as to enable the charger of the charging base to charge wirelessly the rechargeable electrical power source of the lamp. In such instances a method for using the rechargeable lamp can include, with the charging base and the lamp in the separated arrangement, positioning on the charging base a wirelessly rechargeable additional device. Using power provided by the charging base, the wirelessly rechargeable additional device can be at least partially charged, wirelessly, using power provided by the charging base.

In some other instances the charging base can include a first set of one or more electrical charging contacts and the lamp base can include a second set of one or more electrical charging contacts. With the charging base and the lamp base in the charging arrangement, the first and second sets of electrical charging contacts conductively engage one another so as to enable the charger of the charging base to charge the rechargeable electrical power source of the lamp.

Objects and advantages pertaining to rechargeable lamps may become apparent upon referring to the example embodiments illustrated in the drawings and disclosed in the following written description or appended claims.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A through 1I are upper front perspective, lower front perspective, upper rear perspective, top, bottom, left side, right side, front, and back views of an example of a rechargeable lamp including a lamp and a charging base.

FIGS. 2A through 1I are upper front perspective, lower front perspective, upper rear perspective, top, bottom, left side, right side, front, and back views of the charging base of the example rechargeable lamp of FIGS. 1A through 1I.

FIGS. 3A through 3I are upper front perspective, lower front perspective, upper rear perspective, top, bottom, left side, right side, front, and back views of the lamp base of the lamp of the example rechargeable lamp of FIGS. 1A through 1I.

FIG. 4A is a bottom perspective view of another example of a lamp base of a lamp included in a rechargeable lamp; FIG. 4B is a top perspective view of another example of a charging base included in a rechargeable lamp.

The embodiments depicted are shown only schematically; all features may not be shown in full detail or in proper proportion; for clarity certain features or structures may be exaggerated or diminished relative to others or omitted entirely; the drawings should not be regarded as being to scale unless explicitly indicated as being to scale. The embodiments shown are only examples and should not be construed as limiting the scope of the present disclosure or appended claims.

### DETAILED DESCRIPTION

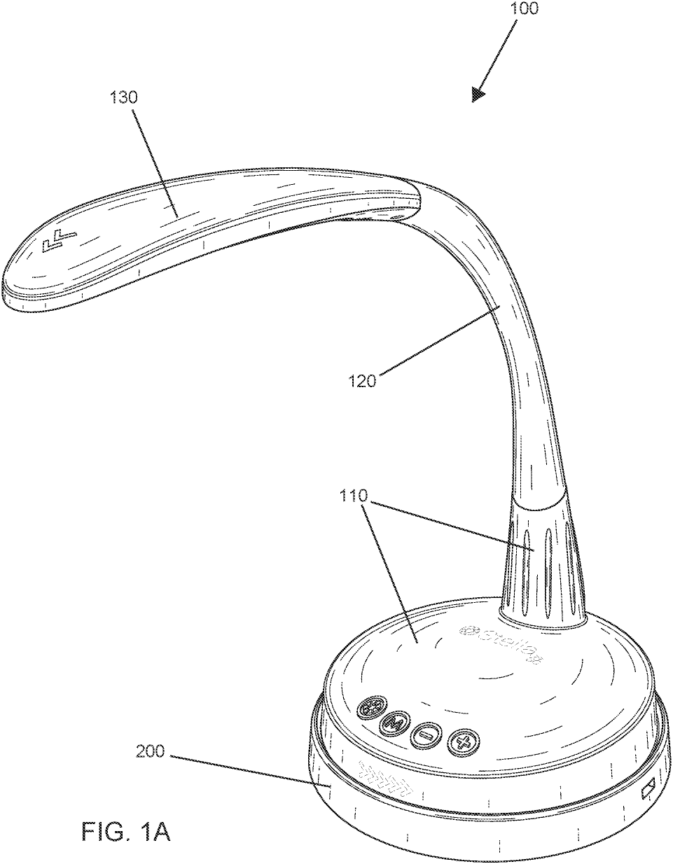

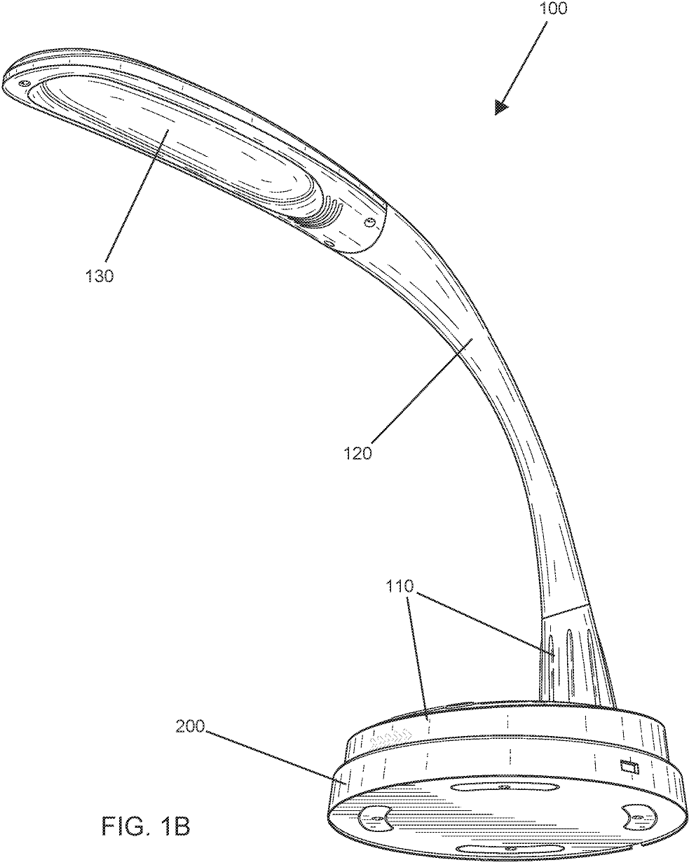

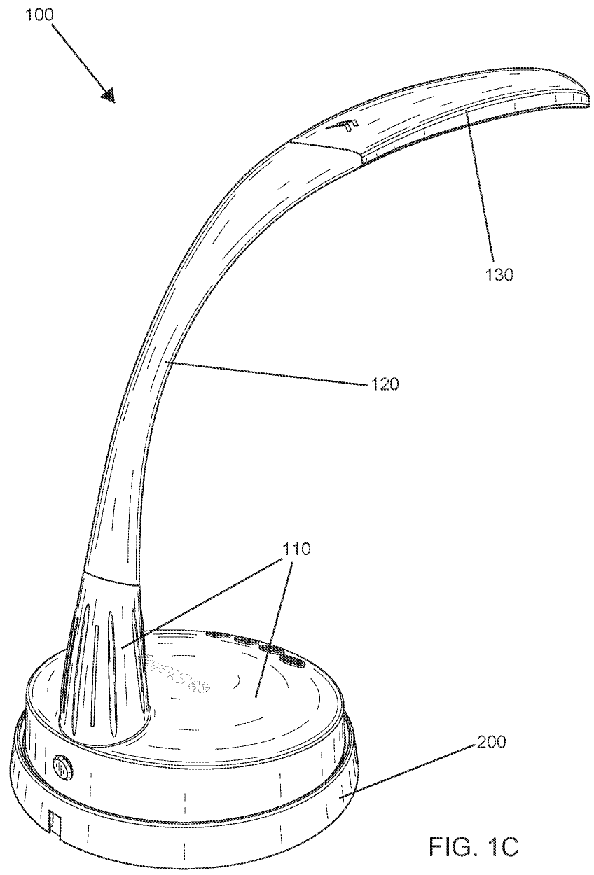

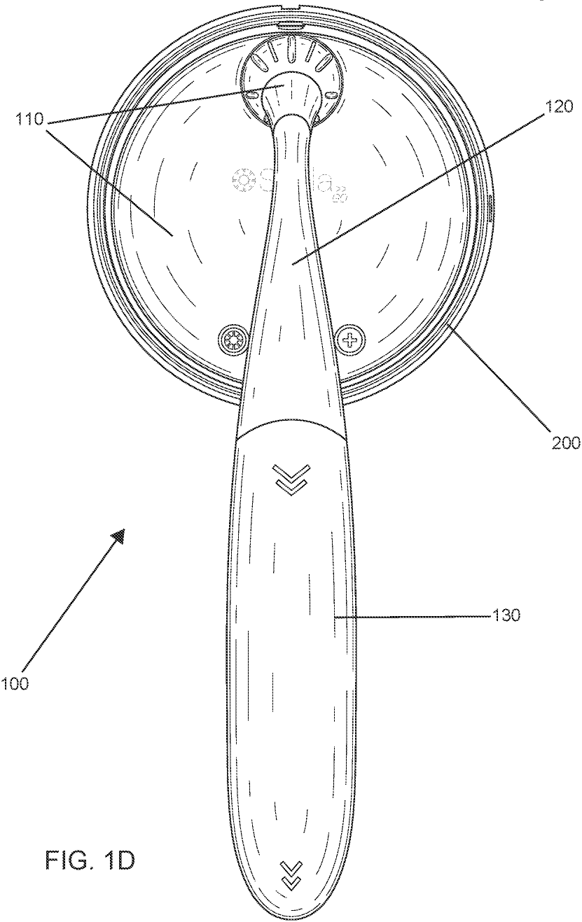

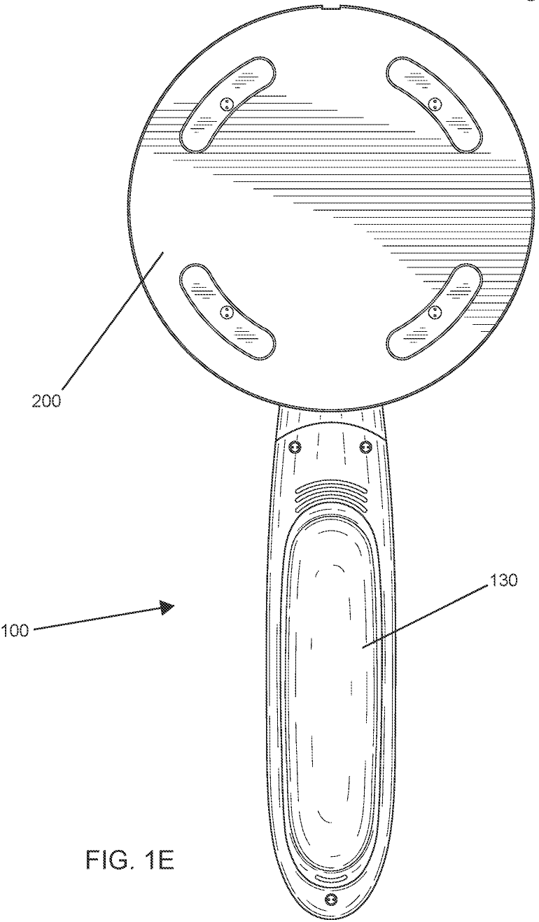

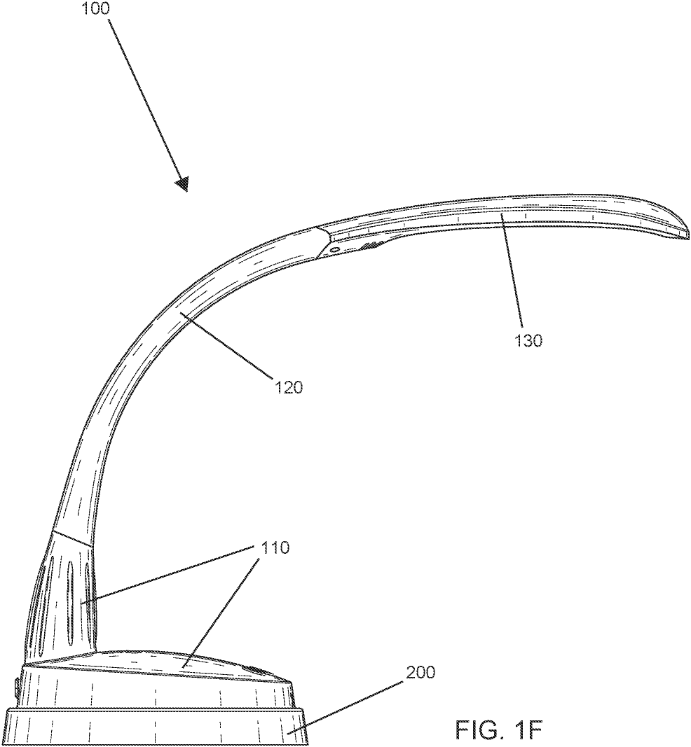

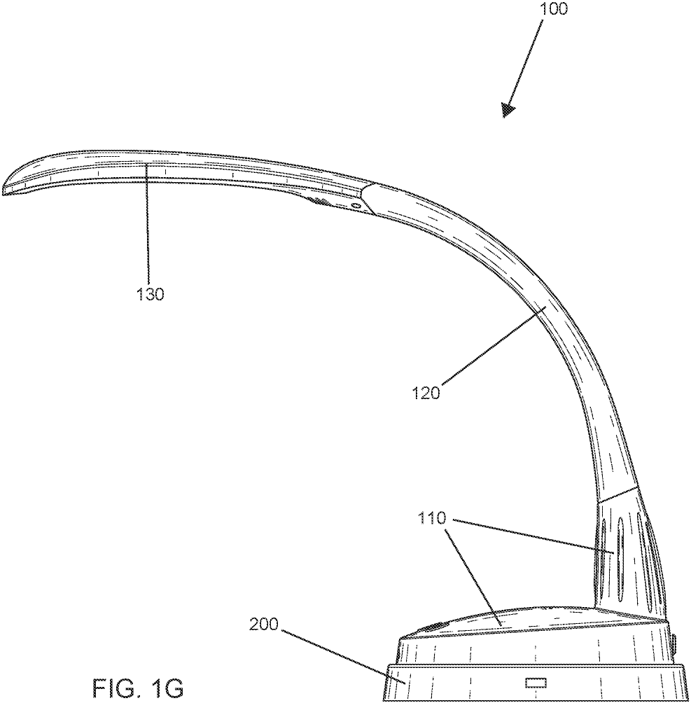

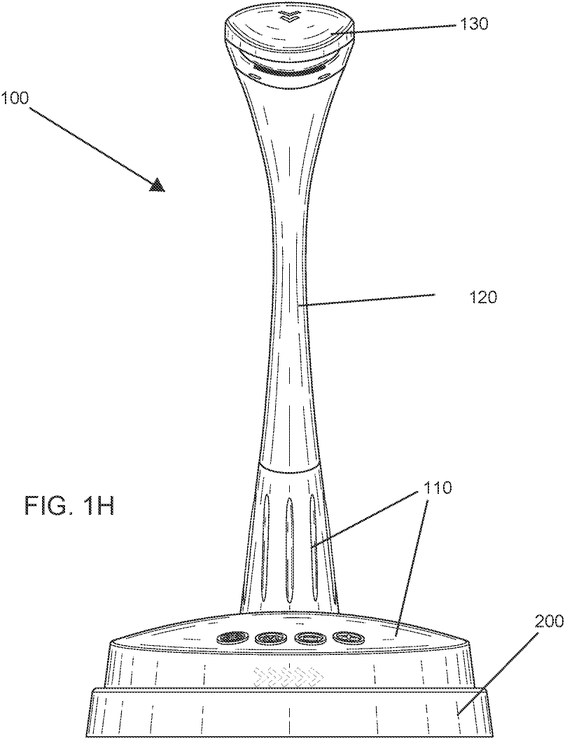

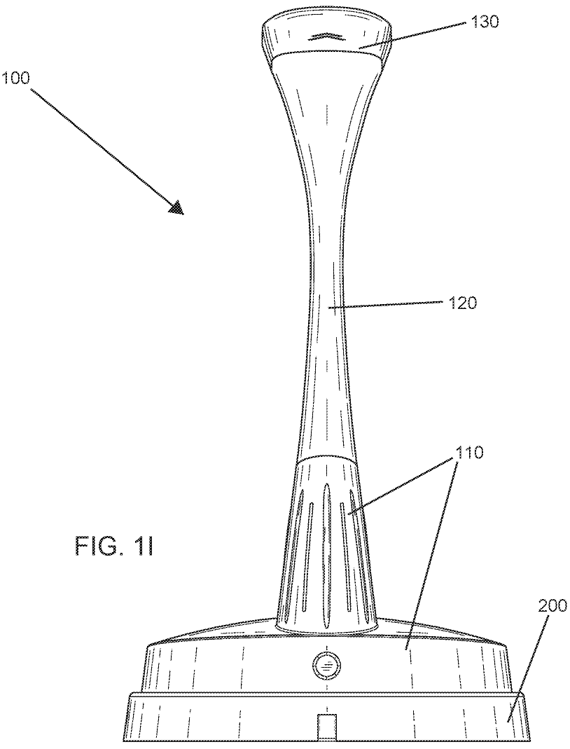

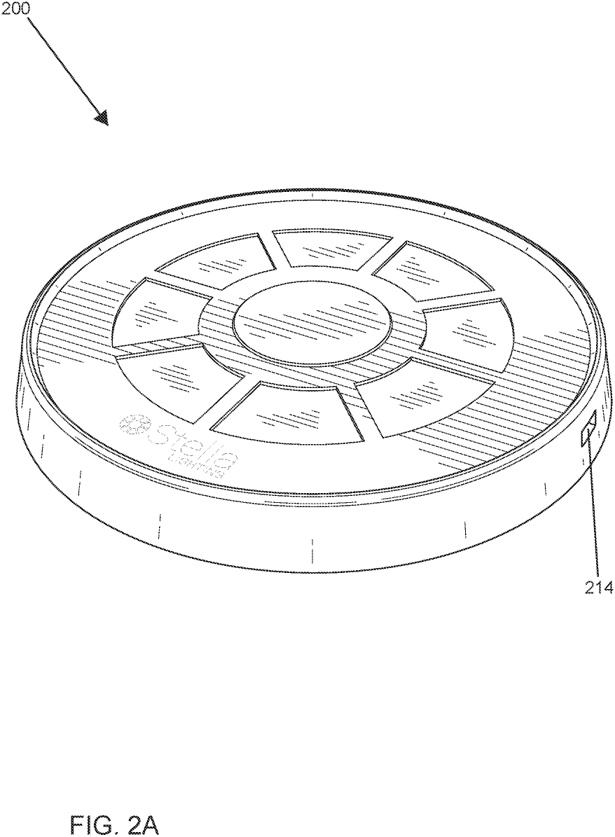

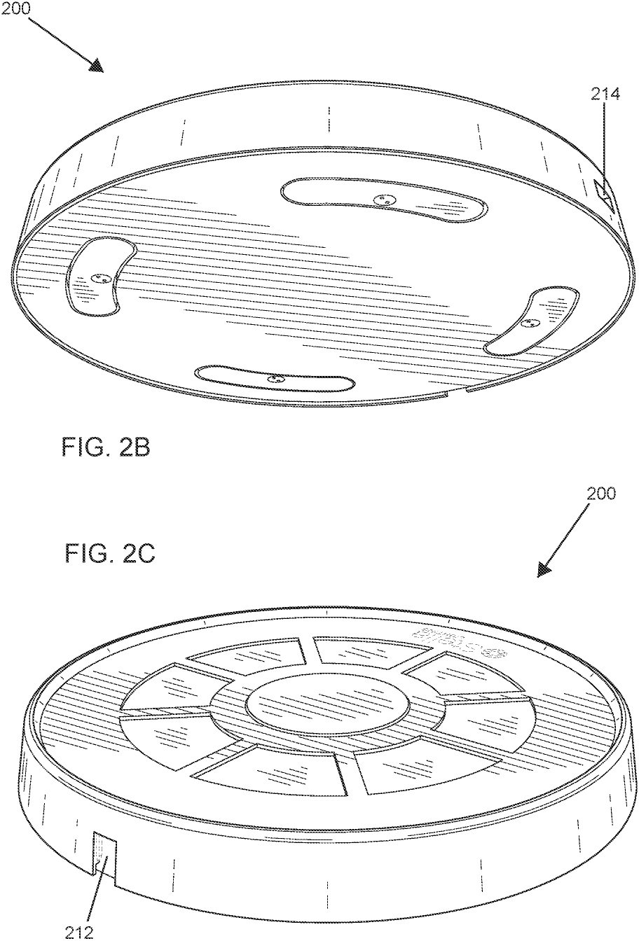

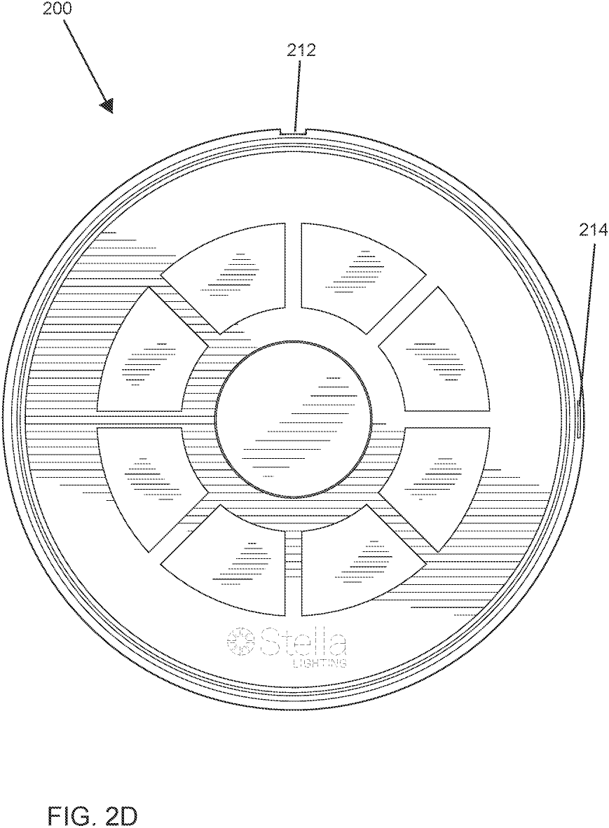

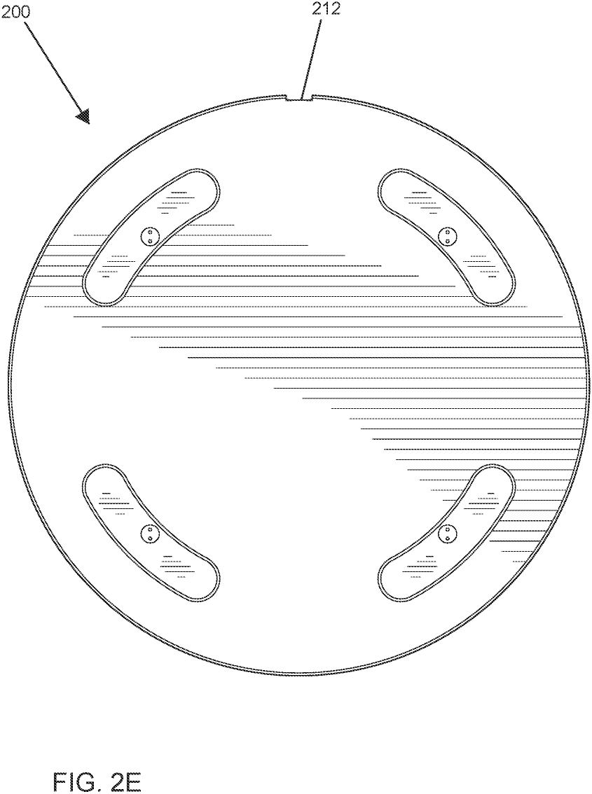

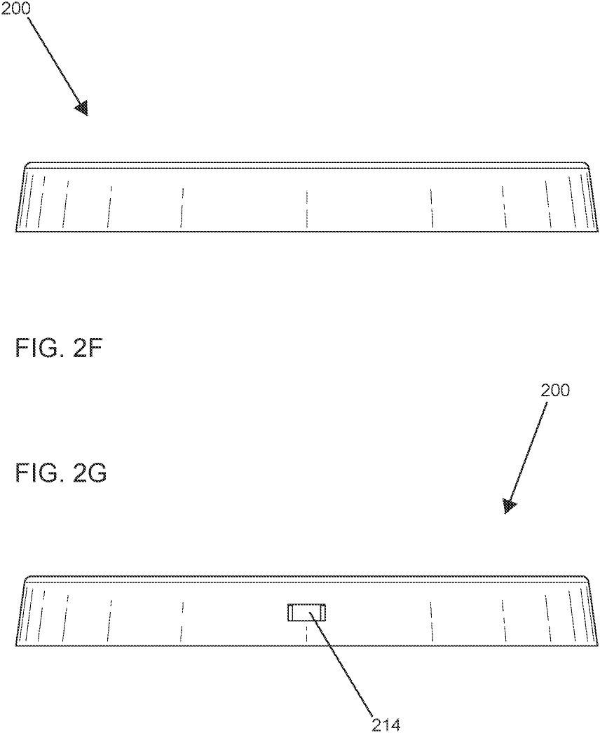

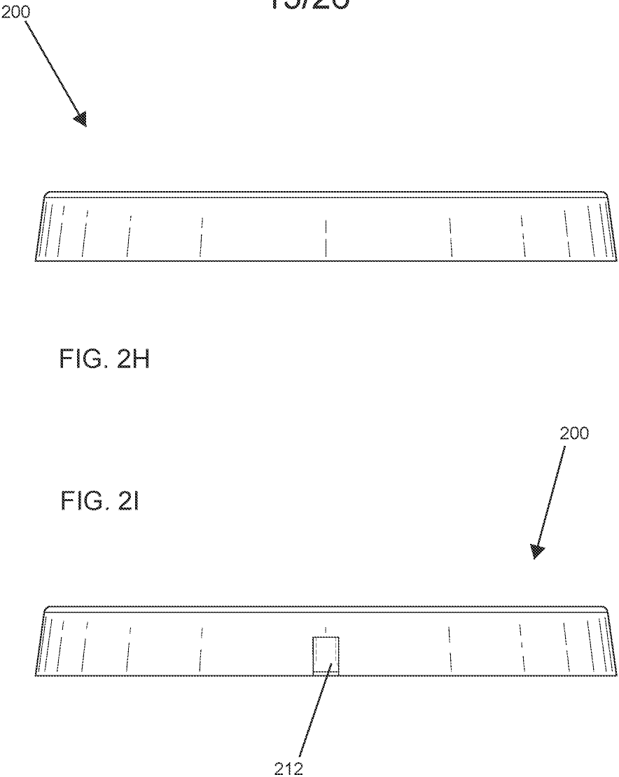

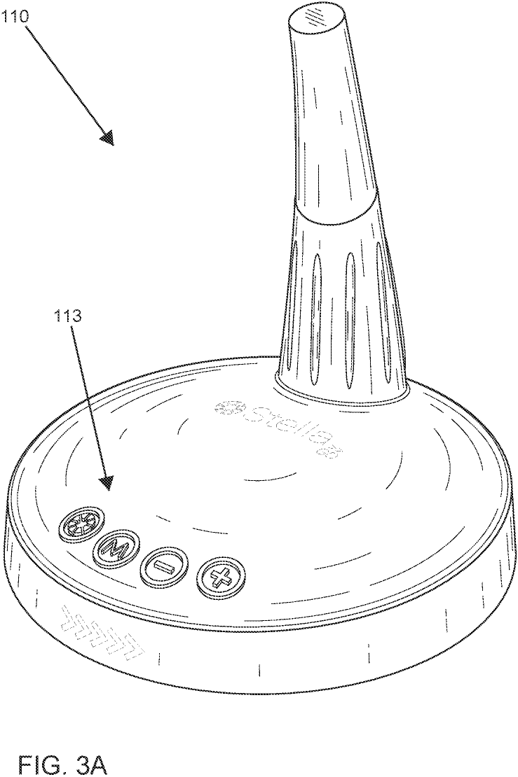

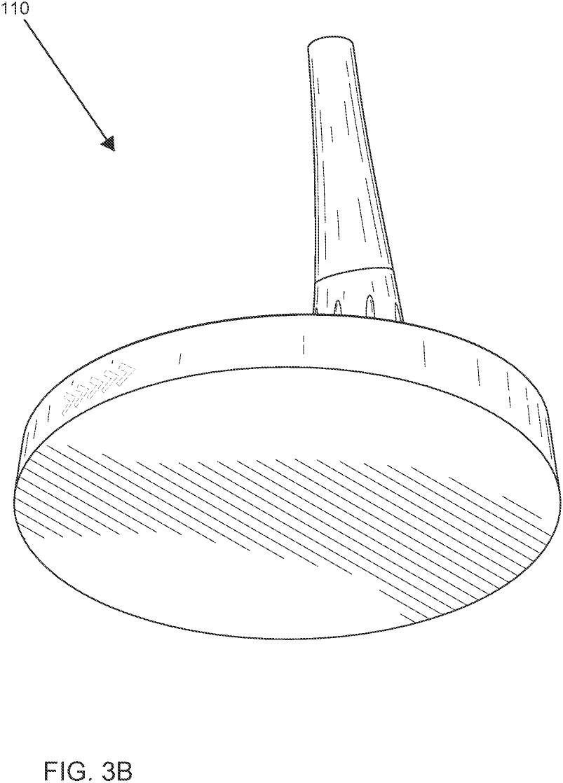

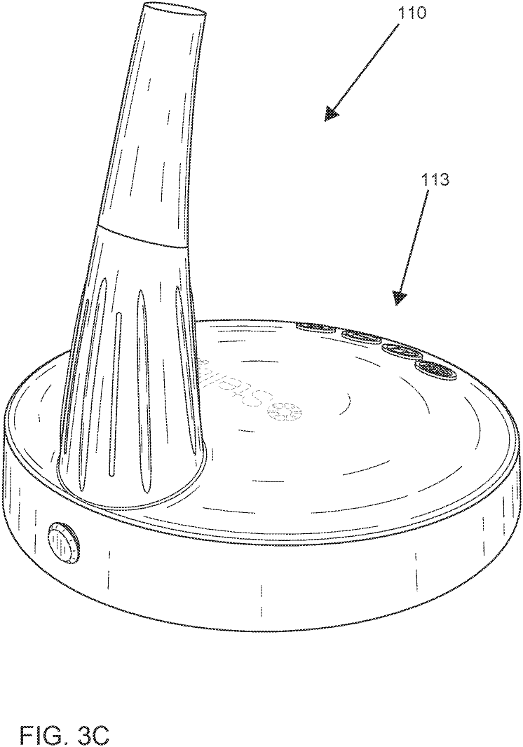

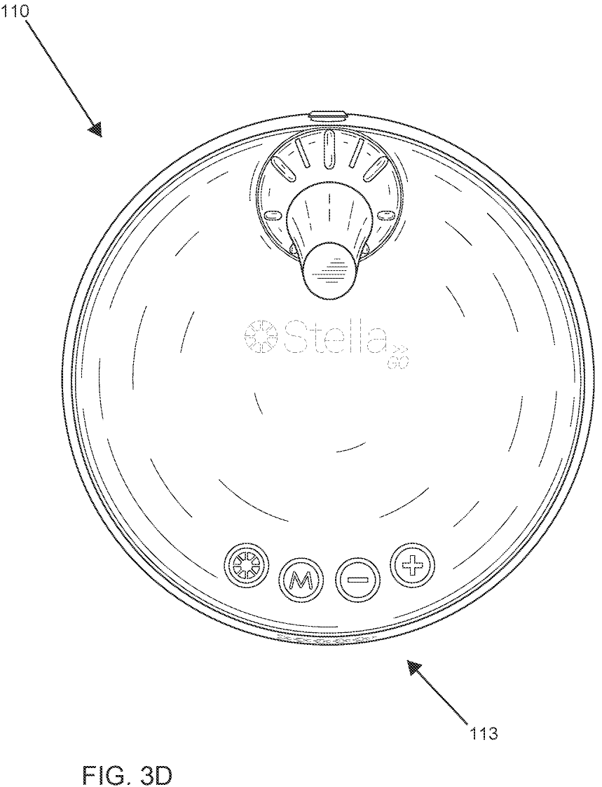

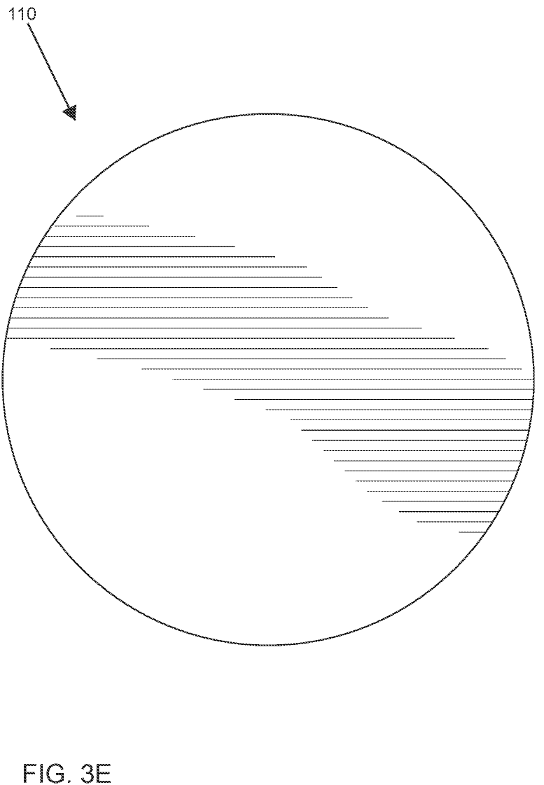

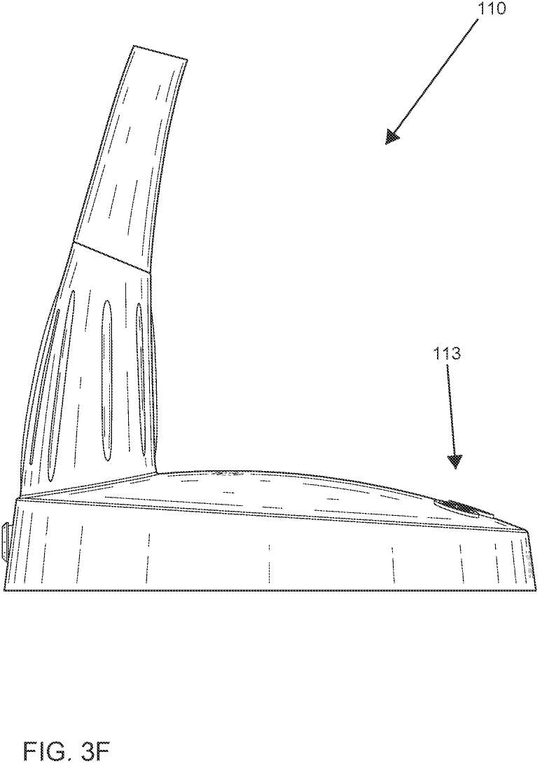

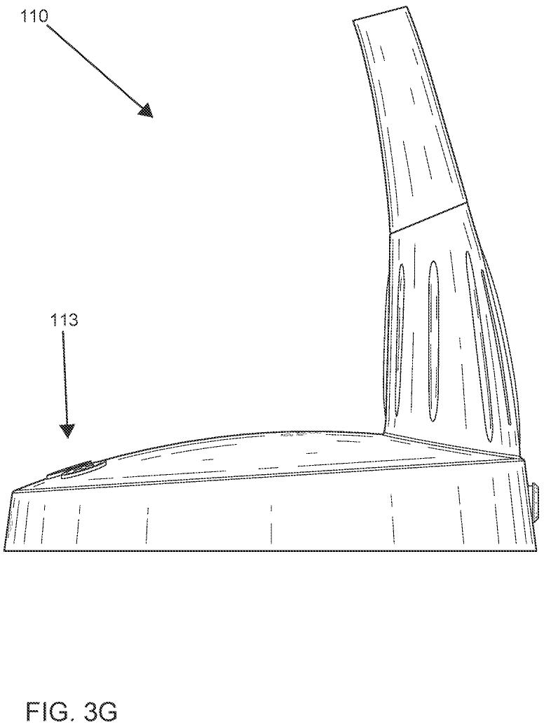

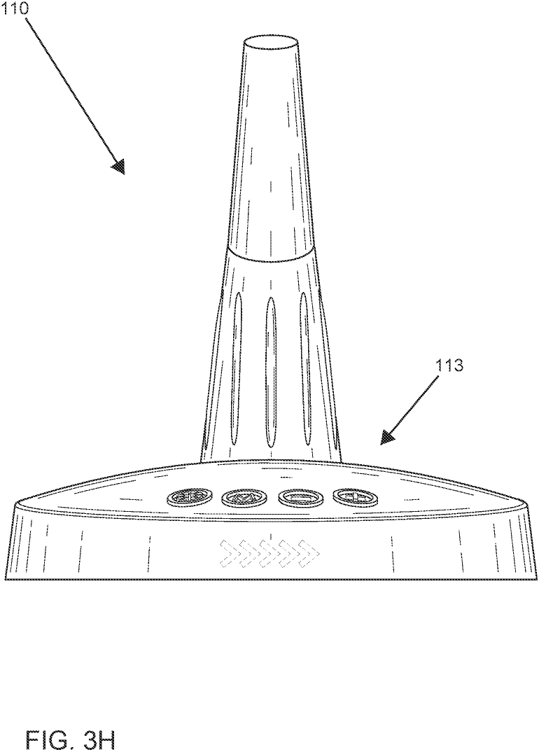

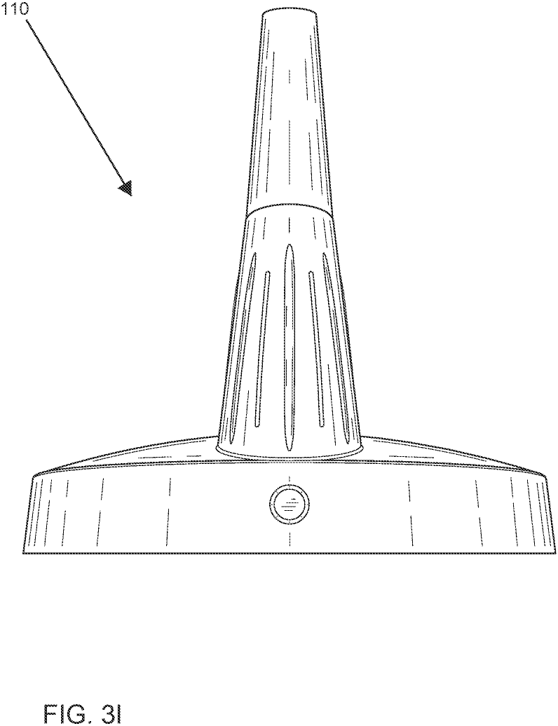

An example of an inventive rechargeable lamp is shown in FIGS. 1A through 1I, and includes a charging base 200 and a lamp 100. The charging base 200 includes an electrical charger and a connection 212 for an external power source. The charger can be of any suitable type or arrangement, and can employ any suitable charging protocol. Any suitable external power source can be employed; AC electric power is often employed, in some instances coupled through an AC/DC converter. The charging base 200 is shown in FIGS. 2A through 2I. The lamp 100 comprises a lamp base 110, a lamp neck 120, a lamp head 130 including a light source, and a rechargeable electric power source that powers the light source. The lamp base is shown in FIGS. 3A through 3I.

The light source can be of any suitable type, including, e.g., one or more light-emitting diodes (LEDs), one or more fluorescent tubes or compact fluorescent bulbs, or one or more incandescent light bulbs. LEDs are often employed, and can be suitably arranged so as to provide light at a desired intensity or color temperature, or at multiple different intensities or color temperatures selectable by a user.

The lamp 100 can be of any suitable type or arrangement, and can be constructed using any one or more suitable materials, e.g., plastic, metal, glass, wood, composite, and so forth. In some examples, including that shown in the drawings, the lamp 100 can be arranged as a desk lamp; the base of the desk lamp example can include control button 113 on the lamp base 110. In other examples, the lamp 100 can be arranged as a table lamp. In still other examples, the lamp 100 can be arranged as a floor lamp. Other suitable arrangements of the lamp 100 can be employed. Any suitable rechargeable electric power source (e.g., one or more rechargeable batteries) can be employed; rechargeable lithium ion batteries are commonly employed.

The charging base 200 and the lamp base 110 are structurally arranged so as to be moveable between a charging arrangement (e.g., as in FIGS. 1A through 1I) and a separated arrangement, in which the lamp 100 has been removed from the charging base 200 and placed elsewhere (e.g., as in FIGS. 2A-2I and 3A-3I). In the charging arrangement, the charging base 200 and the lamp base 110 are engaged so that the charging base 200 supports the lamp 100 in an upright position. The charger of the charging base 200 is coupled with the rechargeable electrical power source of the lamp 100, so that the rechargeable power source of the lamp 100 can be recharged with power provided by the charging base 200. In the separated arrangement, the lamp 100 is portable and self-supporting in an upright position with the lamp base 110 positioned on any suitable substantially horizontal support surface. If sufficiently charged, the lamp 100 enables illumination to be moved to any needed or desired location, including those that may be far removed from ready access to external power (e.g., inconveniently far away from an electrical outlet).

Methods employing an inventive rechargeable lamp comprise: (A) connecting the charging base to an external electrical power source (e.g., plugging a power cord into the external power connection 212 and into an AC electrical outlet); (B) positioning the lamp 100 on the charging base 200 so that they are in the charging arrangement; (C) at least partially charging the rechargeable electric power source of the lamp 100 with electrical power supplied by the charging base 200; and (D) removing the lamp from the charging base (so they are in the separated arrangement) and positioning the lamp in a desired location for providing illumination.

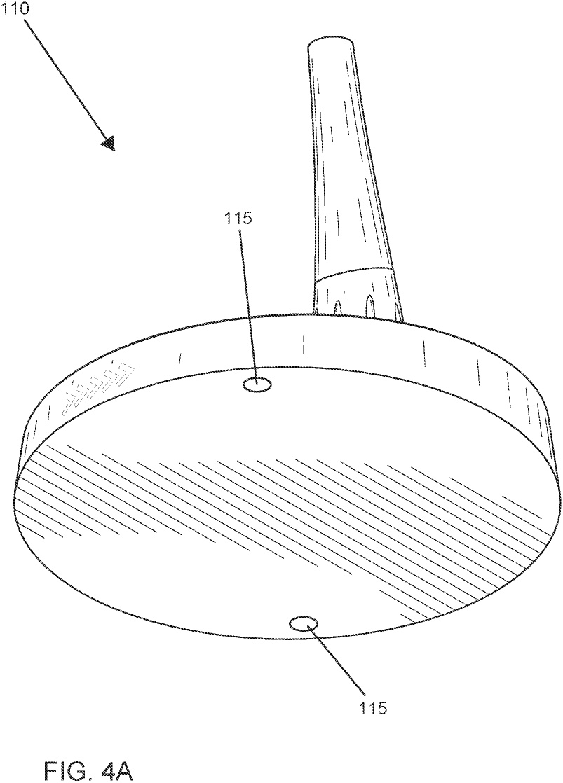

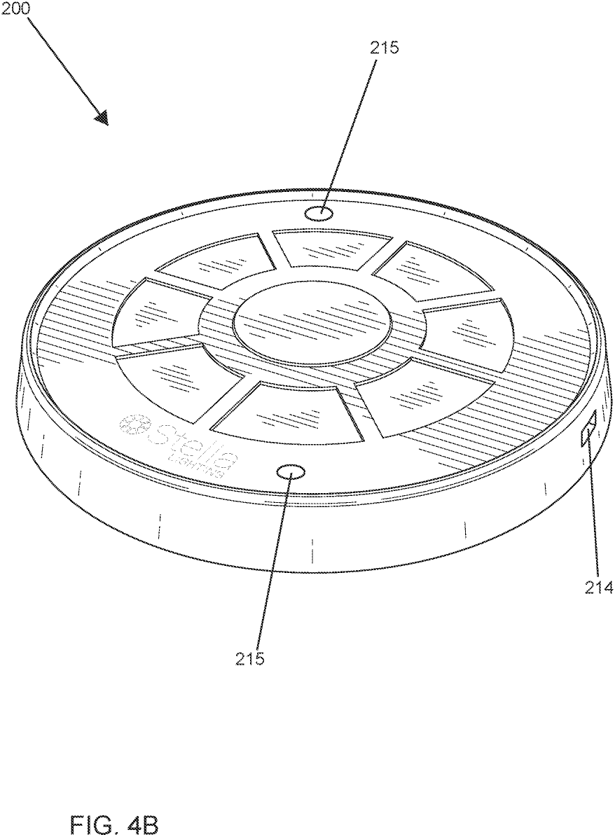

In some examples (e.g., as in FIGS. 4A and 4B), the charging base 200 can include a first set of one or more electrical charging contacts 215, and the lamp base 110 can include a second set of one or more electrical charging contacts 115. With the charging base 200 and the lamp base 110 in the charging arrangement, the first and second sets of electrical charging contacts 115 and 215 conductively engage one another, thereby enabling the charger of the charging base 200 to charge the rechargeable electrical power source of the lamp 100. Such charging might be referred to as “wired” even though there are no literal wires connecting the charging base 200 to the lamp 100.

In some other examples, the charging base 200 can include a first set of one or more inductive coils, and the lamp base 110 can include a second set of one or more inductive coils. With the charging base 200 and the lamp base 110 in the charging arrangement, the first and second sets of conductive coils inductively engage one another so as to enable the charger of the charging base 200 to charge wirelessly the rechargeable electrical power source of the lamp 100. Any suitable wireless charging protocol can be employed. In some wireless charging examples, the sets of inductive coils can be arranged according to a Qi wireless charging protocol or a Powermat wireless charging protocol.

In some wireless charging examples, the charging base 200 can be used to charge other wirelessly rechargeable devices. A corresponding method can comprise: (A) with the charging base 200 and the lamp 100 in the separated arrangement, positioning a wirelessly rechargeable additional device on the charging base; and (B) using power provided by the charging base 200, at least partially charging, wirelessly, the wirelessly rechargeable additional device using power provided by the charging base. The additional device can be removed from the charging base 200 and used after it has been sufficiently recharged. Examples of additional devices can include, e.g., a cell phone or smartphone, another portable light source (e.g., such as a reading light worn around the neck or a headlamp), a tablet computer, a handheld game console, and so forth.

In some examples, regardless of the type of charging of the lamp 100 that is employed (e.g., wired or wireless), the charging base 200 can include an auxiliary electrical port 214. An electrically powered additional device can be connected to and powered or charged by the charging base 200, typically using a suitable wire or cable connected to the port 214. In some of those examples, the auxiliary electrical port 214 can be arranged as a USB port or a Lightning port. A corresponding method can comprise: (A) connecting to the auxiliary electrical port an electrically powered additional device; and (B) operating the electrically powered additional device using power provided by the charging base. Another corresponding method can comprise: (A) connecting to the auxiliary electrical port a rechargeable, electrically powered additional device; and (B) at least partially charging the rechargeable, electrically powered additional device using power provided by the charging base.

In addition to the preceding, the following example embodiments fall within the scope of the present disclosure or appended claims:

Example 1. A rechargeable lamp comprising: (a) a charging base including an electrical charger and a connection for an external electrical power source; and (b) a lamp comprising a lamp base, a lamp neck, a lamp head including a light source, and a rechargeable electric power source structured and connected for powering the light source, wherein: (c) the charging base and the lamp base are structurally arranged so as to be moveable between a charging arrangement and a separated arrangement; (d) with the charging base and the lamp base in the charging arrangement, the charging base and the lamp base are engaged so that the charging base supports the lamp in an upright position and the charger charges the rechargeable electrical power source; and (e) with the charging base and the lamp base in the separated arrangement, the lamp is portable and self-supporting in an upright position with the lamp base positioned on a substantially horizontal support surface.

Example 2. The rechargeable lamp of Example 1 wherein the lamp is configured as a desk lamp.

Example 3. The rechargeable lamp of Example 1 wherein the lamp is configured as a table lamp.

Example 4. The rechargeable lamp of Example 1 wherein the lamp is configured as a floor lamp.

Example 5. The rechargeable lamp of any one of Examples 1 through 4 wherein the light source includes one or more light-emitting diodes.

Example 6. The rechargeable lamp of any one of Examples 1 through 5 wherein the light source includes one or more fluorescent tubes or compact fluorescent bulbs.

Example 7. The rechargeable lamp of any one of Examples 1 through 6 wherein the light source includes one or more incandescent light bulbs.

Example 8. The rechargeable lamp of any one of Examples 1 through 7 wherein the charging base includes an auxiliary electrical port arranged so as to enable an electrically powered additional device to be connected to and powered or charged by the charging base.

Example 9. The rechargeable lamp of Example 8 wherein the auxiliary electrical port is arranged as a USB connector or a Lightning connector.

Example 10. The rechargeable lamp of any one of Examples 1 through 9 wherein the charging base is arranged for connection to an external source of AC electrical power.

Example 11. The rechargeable lamp of any one of Examples 1 through 10 wherein (i) the charging base includes a first set of one or more electrical charging contacts, (ii) the lamp base includes a second set of one or more electrical charging contacts, and (iii) with the charging base and the lamp base in the charging arrangement, the first and second sets of electrical charging contacts are conductively coupled with one another so as to enable the charger of the charging base to charge the rechargeable electrical power source of the lamp.

Example 12. The rechargeable lamp of any one of Examples 1 through 10 wherein (i) the charging base includes a first set of one or more inductive coils, (ii) the lamp base includes a second set of one or more inductive coils, and (iii) with the charging base and the lamp base in the charging arrangement, the first and second sets of conductive coils are inductively coupled with one another so as to enable the charger of the charging base to charge wirelessly the rechargeable electrical power source of the lamp.

Example 13. The rechargeable lamp of Example 12 wherein the first and second sets of inductive coils are arranged according to a Qi wireless charging protocol or a Powermat wireless charging protocol.

Example 14. The method for using the rechargeable lamp of any one of Examples 12 or 13, the method comprising: (A) with the charging base and the lamp in the separated arrangement, positioning on the charging base a wirelessly rechargeable additional device; and (B) at least partially charging, wirelessly, the wirelessly rechargeable additional device using power provided by the charging base.

Example 15. A method for using the rechargeable lamp of any one of Examples 1 through 13, the method comprising: (A) connecting the charging base to an external electrical power source; (B) positioning the lamp on the charging base so that the charging base and lamp are in the charging arrangement; (C) at least partially charging the rechargeable electric power source of the lamp; and (D) removing the lamp from the charging base and, with the charging base and the lamp in the separated arrangement, positioning the lamp in a desired location for providing illumination.

Example 16. A method for using the rechargeable lamp of any one of Examples 8 through 13, the method comprising: (A) connecting to the auxiliary electrical port an electrically powered additional device; and (B) operating the electrically powered additional device using power provided by the charging base.

Example 17. A method for using the rechargeable lamp of any one of Examples 8 through 13, the method comprising: (A) connecting to the auxiliary electrical port a rechargeable, electrically powered additional device; and (B) at least partially charging the rechargeable, electrically powered additional device using power provided by the charging base.

It is intended that equivalents of the disclosed examples (apparatus and methods) shall fall within the scope of the present disclosure or appended claims. It is intended that the disclosed examples, and equivalents thereof, may be modified while remaining within the scope of the present disclosure or appended claims.

The following interpretations shall apply for purposes of the present disclosure and appended claims. The words “comprising,” “including,” “having,” and variants thereof, wherever they appear, shall be construed as open ended terminology, with the same meaning as if a phrase such as “at least” were appended after each instance thereof, unless explicitly stated otherwise. The article “a” shall be interpreted as “one or more” unless “only one,” “a single,” or other similar limitation is stated explicitly or is implicit in the particular context; similarly, the article “the” shall be interpreted as “one or more of the” unless “only one of the,” “a single one of the,” or other similar limitation is stated explicitly or is implicit in the particular context. The conjunction “or” is to be construed inclusively unless: (i) it is explicitly stated otherwise, e.g., by use of “either...or,” “only one of,” or similar language; or (ii) two or more of the listed alternatives are understood or disclosed (implicitly or explicitly) to be incompatible or mutually exclusive within the particular context. In that latter case, “or” would be understood to encompass only those combinations involving non-mutually-exclusive alternatives. In one example, each of “a dog or a cat,” “one or more of a dog or a cat,” and “one or more dogs or cats” would be interpreted as one or more dogs without any cats, or one or more cats without any dogs, or one or more of each. In another example, each of “a dog, a cat, or a mouse,” “one or more of a dog, a cat, or a mouse,” and “one or more dogs, cats, or mice” would be interpreted as (i) one or more dogs without any cats or mice, (ii) one or more cats without and dogs or mice, (iii) one or more mice without any dogs or cats, (iv) one or more dogs and one or more cats without any mice, (v) one or more dogs and one or more mice without any cats, (vi) one or more cats and one or more mice without any dogs, or (vii) one or more dogs, one or more cats, and one or more mice. In another example, each of “two or more of a dog, a cat, or a mouse” or “two or more dogs, cats, or mice” would be interpreted as (i) one or more dogs and one or more cats without any mice, (ii) one or more dogs and one or more mice without any cats, (iii) one or more cats and one or more mice without and dogs, or (iv) one or more dogs, one or more cats, and one or more mice; “three or more,” “four or more,” and so on would be analogously interpreted.

For purposes of the present disclosure or appended claims, when terms are employed such as “about equal to,” “substantially equal to,” “greater than about,” “less than about,” and so forth, in relation to a numerical quantity, standard conventions pertaining to measurement precision and significant digits shall apply, unless a differing interpretation is explicitly set forth. For null quantities described by phrases such as “substantially prevented,” “substantially absent,” “substantially eliminated,” “about equal to zero,” “negligible,” and so forth, each such phrase shall denote the case wherein the quantity in question has been reduced or diminished to such an extent that, for practical purposes in the context of the intended operation or use of the disclosed or claimed apparatus or method, the overall behavior or performance of the apparatus or method does not differ from that which would have occurred had the null quantity in fact been completely removed, exactly equal to zero, or otherwise exactly nulled.

For purposes of the present disclosure and appended claims, any labelling of elements, steps, limitations, or other portions of an embodiment, example, or claim (e.g., first, second, third, etc., (a), (b), (c), etc., or (i), (ii), (iii), etc.) is only for purposes of clarity, and shall not be construed as implying any sort of ordering or precedence of the portions so labelled. If any such ordering or precedence is intended, it will be explicitly recited in the embodiment, example, or claim or, in some instances, it will be implicit or inherent based on the specific content of the embodiment, example, or claim. In the appended claims, if the provisions of 35 USC § 112(f) are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC § 112(f) are not intended to be invoked for that claim.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. A rechargeable lamp comprising:
(a) a charging base including an electrical charger and a connection for an external electrical power source, the charging base including a first set of one or more inductive coils; and
(b) a lamp comprising a lamp base, a lamp neck, a lamp head including a light source, and a rechargeable electric power source structured and connected for powering the light source, the lamp base including a second set of one or more inductive coils, wherein:
(c) the charging base and the lamp base are structurally arranged so as to be moveable between a charging arrangement and a separated arrangement;
(d) with the charging base and the lamp base in the charging arrangement, (i) the charging base and the lamp base are engaged so that the charging base supports the lamp in an upright position, and (ii) the first and second sets of conductive coils are inductively coupled with one another so as to enable the charger of the charging base to charge wirelessly the rechargeable electrical power source of the lamp, the first and second sets of inductive coils being arranged according to a Qi wireless charging protocol or a Powermat wireless charging protocol; and
(e) with the charging base and the lamp base in the separated arrangement, the lamp is portable and self-supporting in an upright position with the lamp base positioned on a substantially horizontal support surface.

2. A method for using the rechargeable lamp of claim 1, the method comprising:
(A) connecting the charging base to an external electrical power source;
(B) positioning the lamp on the charging base so that the charging base and lamp are in the charging arrangement;
(C) at least partially charging the rechargeable electric power source of the lamp; and
(D) removing the lamp from the charging base and, with the charging base and the lamp in the separated arrangement, positioning the lamp in a desired location for providing illumination.

3. The method of claim 2 further comprising:
(E) after part (D) and with the charging base and the lamp in the separated arrangement, positioning on the charging base a wirelessly rechargeable additional device; and
(F) at least partially charging, wirelessly, the wirelessly rechargeable additional device using power provided by the charging base.

4. The method of claim 2 further comprising, before step (B) and with the charging base and the lamp in the separated arrangement, removing from the charging base a wirelessly rechargeable additional device at least partially recharged wirelessly using power provided by the charging base.

5. The rechargeable lamp of claim 1 wherein the lamp is configured as a desk lamp.

6. The rechargeable lamp of claim 1 wherein the lamp is configured as a table lamp.

7. The rechargeable lamp of claim 1 wherein the lamp is configured as a floor lamp.

8. The rechargeable lamp of claim 1 wherein the light source includes one or more light-emitting diodes.

9. The rechargeable lamp of claim 1 wherein the light source includes one or more fluorescent tubes or compact fluorescent bulbs.

10. The rechargeable lamp of claim 1 wherein the light source includes one or more incandescent light bulbs.

11. The rechargeable lamp of claim 1 wherein the charging base is arranged for connection to an external source of AC electrical power.

12. A rechargeable lamp comprising:
(a) a charging base including an electrical charger and a connection for an external electrical power source; and
(b) a lamp comprising a lamp base, a lamp neck, a lamp head including a light source, and a rechargeable electric power source structured and connected for powering the light source, wherein:
(c) the charging base and the lamp base are structurally arranged so as to be moveable between a charging arrangement and a separated arrangement;
(d) with the charging base and the lamp base in the charging arrangement, the charging base and the lamp base are engaged so that the charging base supports the lamp in an upright position and the charger charges the rechargeable electrical power source; and
(e) with the charging base and the lamp base in the separated arrangement, the lamp is portable and self-supporting in an upright position with the lamp base positioned on a substantially horizontal support surface.

13. A method for using the rechargeable lamp of claim 12, the method comprising:
(A) connecting the charging base to an external electrical power source;
(B) positioning the lamp on the charging base so that the charging base and lamp are in the charging arrangement;
(C) at least partially charging the rechargeable electric power source of the lamp; and
(D) removing the lamp from the charging base and, with the charging base and the lamp in the separated arrangement, positioning the lamp in a desired location for providing illumination.

14. The rechargeable lamp of claim 12 wherein the charging base is arranged for connection to an external source of AC electrical power.

15. The rechargeable lamp of claim 12 wherein (i) the charging base includes a first set of one or more electrical charging contacts, (ii) the lamp base includes a second set of one or more electrical charging contacts, and (iii) with the charging base and the lamp base in the charging arrangement, the first and second sets of electrical charging contacts are conductively coupled with one another so as to enable the charger of the charging base to charge the rechargeable electrical power source of the lamp.

16. The rechargeable lamp of claim 12 wherein the charging base includes an auxiliary electrical port arranged so as to enable an electrically powered additional device to be connected to and powered or charged by the charging base.

17. The rechargeable lamp of claim 16 wherein the auxiliary electrical port is arranged as a USB connector or a Lightning connector.

18. A method for using the rechargeable lamp of claim 16, the method comprising:
(A) connecting to the auxiliary electrical port an electrically powered additional device; and
(B) operating the electrically powered additional device using power provided by the charging base.

19. A method for using the rechargeable lamp of claim 16, the method comprising:
(A) connecting to the auxiliary electrical port a rechargeable, electrically powered additional device; and
(B) at least partially charging the rechargeable, electrically powered additional device using power provided by the charging base.
